(19) United States
(12) Patent Application Publication
(10) Pub. No.: US 2015/0241048 A1
(43) Pub. Date: Aug. 27, 2015

(54) Illuminating Device

(71) Applicant: OSRAM GMBH, München (DE)

(72) Inventors: Tingbiao Lan, Shenzhen (CN); Jin Hu, Shenzhen (CN); Jing Lin, Shenzhen (CN); Hui Gui, Shenzhen (CN)

(21) Appl. No.: 14/427,995

(22) PCT Filed: Aug. 29, 2013
(86) PCT No.: PCT/EP2013/067910

§ 371 Date: Mar. 13, 2015

(30) Foreign Application Priority Data
Sep. 14, 2012 (CN) 201210343268.6

(51) Int. Cl. F21V 29/70; F21V 5/04; F21V 15/01

(52) U.S. Cl. CPC F21V 29/70; F21V 15/01; F21V 5/04; F21Y 2101/02

(57) ABSTRACT

Various embodiments may relate to an illuminating device including a heat sink, a lens and an electronic device housing. The heat sink includes a circumferential wall that defines an accommodating cavity having a first opening and a second opening that are opposite, the lens and the electronic device housing are mounted in the accommodating cavity from the first opening and the second opening, respectively. One of the lens and the electronic device housing is fixed to the circumferential wall and is fixed together with the other one of the lens and the electronic device housing.

### RELATED APPLICATIONS

The present application is a national stage entry according to 35 U.S.C. §371 of PCT application No.: PCT/EP2013/067910 filed on Aug. 29, 2013, which claims priority from Chinese application No.: 201210343268.6 filed on Sep. 14, 2012, and is incorporated herein by reference in its entirety.

### TECHNICAL FIELD

Various embodiments relate to an illuminating device.

### BACKGROUND

With continuous progress of technology, the LED light source is widely used in the illuminating device, due to advantages of energy saving, long service lifetime and high light-emitting efficiency, to replace the light sources of the conventional illuminating device. However, light emitted from the LED light source, thanks to its properties, should be equipped with an additional lens so as to conduct secondary optical processing on the emitted light for obtaining expected illumination effect. In addition, the LED light source has a high requirement on temperature, and efficiency of the LED light source will be gradually decreased with continuous rising of the operation temperature. Besides, the service lifetime of the LED light source also will be reduced for a long term operation under high temperatures, thus, a specially designed heat sink should be equipped for the LED light source. Moreover, the LED light source also needs a driver to drive it to operate. The driver is usually arranged in a driver housing which is, however, fixed to the heat sink, similarly, the lens also should be fixed in the heat sink so as to obtain a complete illuminating device.

In the related art, the driver housing and the lens usually have a snap connection device, respectively, therefore, corresponding cooperation structures, e.g. grooves, should be provided on the heat sink for the snap connection devices of the driver housing and the lens, respectively. However, these grooves should be formed independently through other process such as lathe turning process after the heat sink is fabricated. This prominently increases the manufacturing cost and time of the heat sink.

### SUMMARY

Various embodiments provide an illuminating device. Various parts of the illuminating device can be reliably connected together, and meanwhile, the structure thereof is simpler, has a low cost and is easily assembled.

The illuminating device includes a heat sink, a lens and an electronic device housing, wherein the heat sink includes a circumferential wall that defines an accommodating cavity having a first opening and a second opening that are opposite, the lens and the electronic device housing are mounted in the accommodating cavity from the first opening and the second opening, respectively, wherein one of the lens and the electronic device housing is fixed to the circumferential wall and is fixed together with the other one of the lens and the electronic device housing. In various embodiments, only the lens or the electronic device housing needs to be fixed on the heat sink, without the need of forming fixed structures for the lens and the electronic device housing, respectively, on the heat sink. As a result, the processing steps of fabricating the heat sink are reduced, the structure complexity of the heat sink is decreased, and the cost of the whole illuminating device is lowered.

In various embodiments, at least one first locking structure is formed on the circumferential wall, at least one second locking structure is formed on the lens, at least one third locking structure is formed on the electronic device housing, one of the second locking structure and the third locking structure forms locking connection with the first locking structure and includes a fourth locking structure, and the other one of the second locking structure and the third locking structure is in locking connection with the fourth locking structure. Through the simple locking connection, one of the lens and the electronic device housing can be in locking connection with the heat sink, and the lens and the electronic device housing together can be in locking connection. The mode of locking connection has a simple structure and is easy to realize. Moreover, the mode of locking connection is more favorable for assembling and dissembling. When a part of the illuminating device fails, the locking connection can be simply released without damaging the lens or the electronic device housing, which improves the service lifetime of the illuminating device to a great extent.

Preferably, the first locking structure is configured as a groove formed in the circumferential wall, and a stop is formed in the groove. The locking structure of the lens or the electronic device housing can be locked with the stop so that the lens or the electronic device housing is reliably connected to the heat sink.

Preferably, the groove includes a first groove portion and a second groove portion that have different depths, wherein a transition region between the first groove portion and the second groove portion forms a step portion used as the stop. The groove itself is easily fabricated as its structure is quite simple. Jointly forming the groove with two groove portions having different depths can advantageously avoid a step of independently forming the stop in the groove latter on, which reduces the manufacturing difficulty and cost of the illuminating device to a great extent. In addition, such groove formed on the circumferential wall further serves a function of guiding the locking structure on the lens or the electronic device housing. The locking structure can slide along a part of the groove having a small depth so that assembling personal can easily align the locking structure with the stop in the groove, prominently improving the assembling efficiency.

In various embodiments, the groove extends in the whole circumferential wall in a direction from one of the first opening and the second opening to the other. Such structure of the groove is quite favorable, because, in order to form the groove as the first locking structure, the groove is usually formed in the circumferential wall through an injection molding process or a die casting process, and a mould should be taken off at the end of the procedure when the heat sink is fabricated through the above process, while the groove itself is opened in the circumferential wall in a longitudinal direction, the mould thus can be easily taken off without causing any unnecessary hindrance to demoulding. Besides, since the first locking structure is formed in one piece while the heat sink is formed, the procedure of forming the first locking structure independently on the heat sink is avoided after forming the heat sink.

Preferably, the second locking structure includes a first elastic arm and a first hook formed at a free end of the first elastic arm.

According to various embodiments, the fourth locking structure is configured as a notch formed in the first elastic arm, and the first hook is snapped in the notch after the lens is inserted into the accommodating cavity. Reliable connection between the lens and the electronic device housing can be realized just by snapping the first hook in the notch, and the third locking structure of the electronic device housing is in locking connection with the stop in the circumferential wall of the heat sink, thereby realizing reliable fixed connection between the lens and the electronic device housing and the heat sink.

Preferably, the third locking structure includes a second elastic arm and a second hook formed at a free end of the second elastic arm.

According to various embodiments, the fourth locking structure is configured as a notch formed in the second elastic arm, and the second hook is snapped in the notch after the electronic device housing is inserted into the accommodating cavity. Reliable connection between the lens and the electronic device housing can be realized just by snapping the second hook in the notch, and the second locking structure of the lens is in locking connection with the stop in the circumferential wall of the heat sink, thereby realizing reliable fixed connection between the lens and the electronic device housing and the heat sink.

Preferably, the heat sink further includes a separator that separates the accommodating cavity into a first accommodating cavity portion and a second accommodating cavity portion. The separator advantageously electrically insulates the first accommodating cavity portion and the second accommodating cavity portion so as to prevent electrical contact between electronic devices arranged in the two accommodating cavity portions and even risk of short-circuit.

Advantageously, at least one via hole allowing the second locking structure or the third locking structure to run therethrough is formed in the separator. Such via hole can allow the second locking structure or the third locking structure to be capable of entering from one accommodating cavity portion into the other accommodating cavity portion, so as to be locked with the stop or the fourth locking structure in the other accommodating cavity portion.

According to various embodiments, the illuminating device further includes a light source and a driver driving the light source, the driver is accommodated in the driver housing, wherein the light source is arranged in the first accommodating cavity portion, and the driver housing accommodating the driver is arranged in the second accommodating cavity portion.

Preferably, the light source includes at least one LED chip. The LED chip has advantages of high light-emitting efficiency, environmental friendliness and long service lifetime.

It is to be understood that the features of the various exemplary embodiments described herein may be combined with each other, unless specifically noted otherwise.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a cross section diagram of an illuminating device according to the present disclosure;

FIG. 2 is a perspective diagram of a heat sink of the illuminating device according to the present disclosure;

FIG. 3 is a cross section diagram of the heat sink of the illuminating device according to the present disclosure;

FIG. 4 is a cross section diagram of a first embodiment of the illuminating device according to the present disclosure, wherein a lens is not shown in the figure; and

FIG. 5 is a cross section diagram of a first embodiment of the illuminating device according to the present disclosure, wherein the lens and an electronic device housing have been assembled to the heat sink.

### DETAILED DESCRIPTION

In the following detailed description, reference is made to the accompanying drawings, which form a part hereof, and in which is shown by way of illustration specific embodiments in which the disclosure may be practiced. In this regard, directional terminology, such as “top”, “bottom”, “upper”, “lower”, “circumferential”, “longitudinal”, is used in reference to the orientation of the figures being described. Because components of embodiments of the present disclosure can be positioned in a number of different orientations, the directional terminology is used for purposes of illustration and is in no way limiting. It is to be understood that other embodiments may be utilized and structural or logical changes may made without departing from the scope of the present disclosure. The following detailed description, therefore, is not to be taken in a limiting sense, and the scope of the present disclosure is defined by the appended claims.

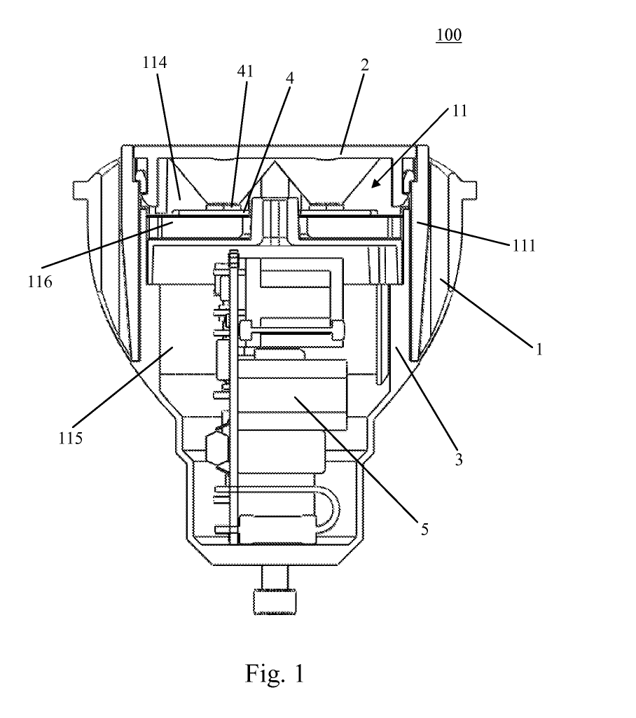

FIG. 1 is a cross section diagram of an illuminating device 100 according to the present disclosure. It can be seen from the figure that the illuminating device 100 includes: a heat sink 1, a lens 2 and an electronic device housing 3, wherein the heat sink 1 includes a circumferential wall 111 that defines an accommodating cavity 11 having a first opening and a second opening that are opposite, the lens 2 and the electronic device housing 3 are mounted in the accommodating cavity 11 from the first opening and the second opening, respectively, wherein one of the lens 2 and the electronic device housing 3 is fixed to the circumferential wall 111 and is fixed together with the other one of the lens 2 and the electronic device housing 3.

In the embodiment shown in FIG. 1, the electronic device housing 3 is fixed to the circumferential wall 111, and the lens 2 is fixed to the electronic device housing 3. In another embodiment not shown, the lens 2 can be fixed to the circumferential wall 11, and the electronic device housing 3 is fixed to the lens 2.

In addition, it can be seen further from FIG. 1 that the heat sink 1 further includes a separator 116 that separates the accommodating cavity 11 into a first accommodating cavity portion 114 and a second accommodating cavity portion 115. The illuminating device 100 further includes a light source 4 and a driver 5 driving the light source, and the driver 5 is accommodated in the driver housing 3, wherein the light source 4 is arranged in the first accommodating cavity portion 114, and the driver housing 3 accommodating the driver 5 is arranged in the second accommodating cavity portion 115. In the present embodiment, the light source 4 includes at least one LED chip 41.

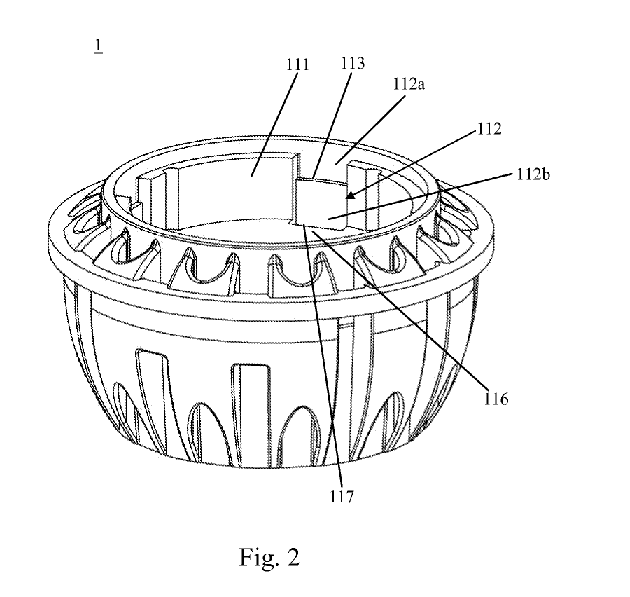

FIG. 2 is a perspective diagram of the heat sink 1 of the illuminating device 100 according to the present disclosure. It can be seen from the figure that the circumferential wall 111 of the heat sink 1 defines the accommodating cavity 11 having the first opening and the second opening opposite to each other, a plurality of first locking structures are formed on the circumferential wall 111, and respective first locking structure is configured as a groove 112 formed in the circumferential wall 111, and a stop is formed in the groove 112. It can be seen from FIG. 2 that the groove 112 includes a first groove portion 112a and a second groove portion 112b that have different depths, wherein a transition region between the first groove portion 112a and the second groove portion 112b forms a step portion 113 used as the stop. In addition, it can be seen further from FIG. 2 that the heat sink 1 further includes the separator 116 that separates the accommodating cavity 11 of the heat sink 1 into the first accommodating cavity portion 114 and the second accommodating cavity portion 115, and at least one via hole 117 is further formed on the separator 116.

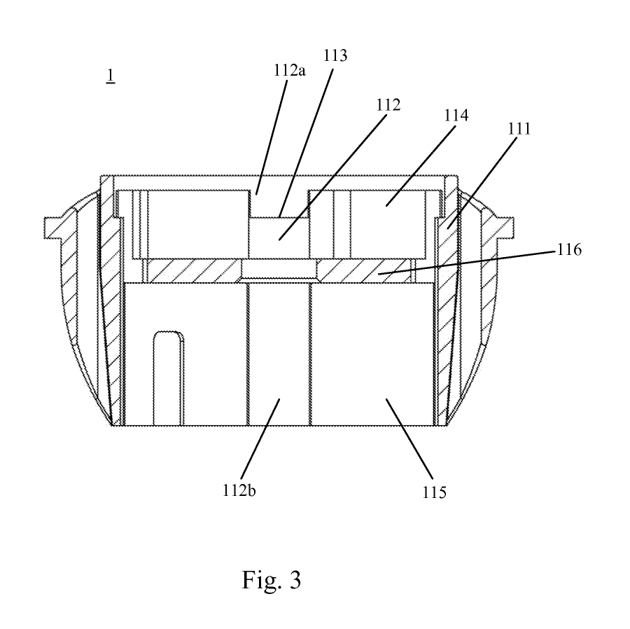

FIG. 3 is a cross section diagram of the heat sink 1 of the illuminating device 100 according to the present disclosure. It can be seen clearly from the figure that the circumferential wall 111 of the heat sink 1 defines the accommodating cavity 11 having the first opening and the second opening. In addition, it can be seen further from FIG. 3 that the groove 112 extends in the whole circumferential wall 111 in a direction from one of the first opening and the second opening to the other, that is to say, the groove 112 extends in the whole longitudinal direction of the circumferential wall 111. This is quite favorable for forming in one piece the heat sink 1 and the grooves 112 on the heat sink 1 through an injection molding process or a die casting process, because a mould should be taken off at the end of the procedure when the heat sink 1 is fabricated through the above process, while the grooves 112 themselves are opened in the circumferential wall in the longitudinal direction, the mould thus can be easily taken off without causing any unnecessary hindrance to demoulding.

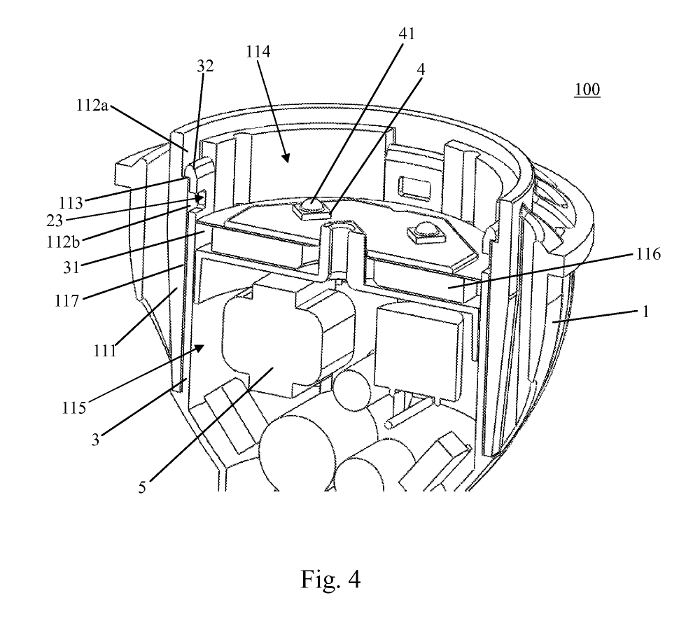

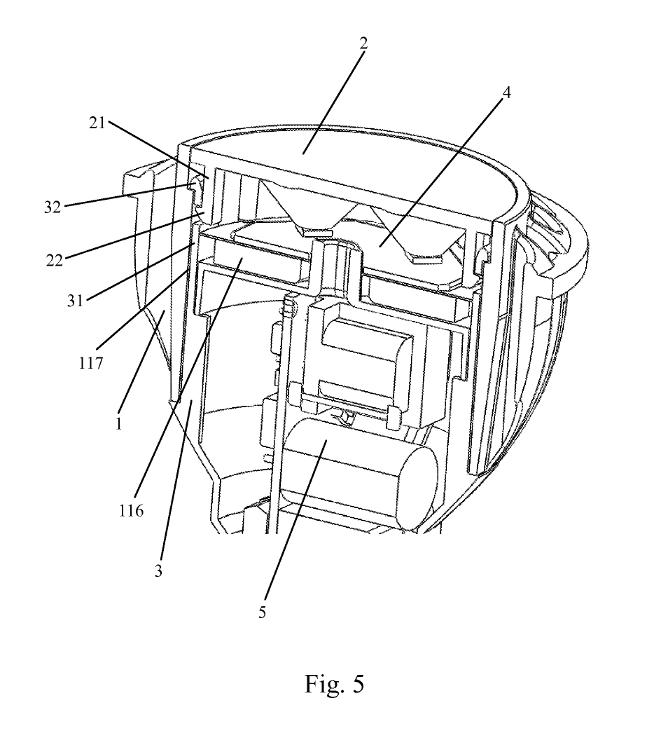

FIG. 4 is a cross section diagram of a first embodiment of the illuminating device 100 according to the present disclosure, wherein the lens 2 is not shown in the figure. In the present embodiment, at least one third locking structure is formed on the electronic device housing 3, and the third locking structure includes a second elastic arm 31 and a second hook 32 formed at a free end of the second elastic arm 31. In addition, it can be seen from FIG. 4 that a notch 23 configured as a fourth locking structure is formed in the second elastic arm 31. In the state shown in FIG. 4, the second elastic arm 31 of the electronic device housing 3 is inserted into the accommodating cavity 11 from below the heat sink 1, i.e. from a direction of an opening end of the second accommodating cavity portion 115, and the second hook 32 slides in a direction from the second groove portion 112b of the groove 112 having a small depth to the first accommodating cavity portion 114, and runs through the via hole 117 formed in the separator 116 until the second hook 32 is locked with the stop 113, so that the electronic device housing 3 is locked to the heat sink 1. At lest one second locking structure is formed on the lens 2, and the second locking structure includes a first elastic arm 21 and a first hook 22 (see FIG. 5) formed at a free end of the first elastic arm 21. In the present embodiment, the lens 2 is inserted into the accommodating cavity 11 from above the heat sink 1, i.e. from a direction of an opening end of the first accommodating cavity portion 114, and the first hook 21 is locked in the notch 23 formed in the second elastic arm 31 so as to realize locking connection between the lens 2 and the electronic device housing 3.

However, in other embodiments of the present disclosure, the lens 2 also can be in locking-fixed connection with the heat sink 1, and the notch 23 that is configured as the fourth locking structure is formed on the first elastic arm 21 of the lens 2, while the second hook 32 of the electronic device housing 3 is snapped in the notch 23, so as to form a locking connection between the electronic device housing 3 and the lens 2.

FIG. 5 is a cross section diagram of a first embodiment of the illuminating device 100 according to the present disclosure, wherein the electronic device housing 3 and the lens 2 have been assembled to the heat sink 1. It can be seen from the figure that the lens 2 is inserted into the accommodating cavity 1 from above the heat sink 1, i.e. from the direction of the opening end of the first accommodating cavity portion 114, and the first hook 21 is snapped in the notch 23 formed in the second elastic arm 31 so as to realize the locking connection between the lens 2 and the electronic device housing 3.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An illuminating device, comprising:
a heat sink,
a lens and
an electronic device housing,
wherein the heat sink comprises a circumferential wall that defines an accommodating cavity having a first opening and a second opening that are opposite, the lens and the electronic device housing are at least mounted in the accommodating cavity from the first opening and the second opening, respectively,
wherein one of the lens and the electronic device housing is fixed to the circumferential wall and is fixed together with the other one of the lens and the electronic device housing.

2. The illuminating device according to claim 1, wherein at least one first locking structure is formed on the circumferential wall, at least one second locking structure is formed on the lens, at least one third locking structure is formed on the electronic device housing, one of the second locking structure and the third locking structure forms locking connection with the first locking structure and comprises a fourth locking structure, and the other one of the second locking structure and the third locking structure is in locking connection with the fourth locking structure.

3. The illuminating device according to claim 2, wherein the first locking structure is configured as a groove formed in the circumferential wall, and a stop is formed in the groove.

4. The illuminating device according to claim 3, wherein the groove comprises a first groove portion and a second groove portion that have different depths, wherein a transition region between the first groove portion and the second groove portion forms a step portion as the stop.

5. The illuminating device according to claim 3, wherein the groove extends over the whole circumferential wall in a direction from one of the first opening and the second opening to the other.

6. The illuminating device according to claim 4, wherein the second locking structure comprises a first elastic arm and a first hook formed at a free end of the first elastic arm.

7. The illuminating device according to claim 6, wherein the fourth locking structure is configured as a notch formed in the first elastic arm, and the first hook is snapped in the notch after the lens is inserted into the accommodating cavity.

8. The illuminating device according to claim 4, wherein the third locking structure comprises a second elastic arm and a second hook formed at a free end of the second elastic arm (31).

9. The illuminating device according to claim 8, wherein the fourth locking structure is configured as a notch formed in the second elastic arm, and the second hook is snapped in the notch after the electronic device housing is inserted into the accommodating cavity.

10. The illuminating device according to claim 2,
wherein the first locking structure is formed in the circumferential wall in one piece through an injection molding process or a die casting process.

11. The illuminating device according to claim 2,
wherein the heat sink further comprises a separator that separates the accommodating cavity into a first accommodating cavity portion and a second accommodating cavity portion.

12. The illuminating device according to claim 11, wherein at least one via hole allowing the second locking structure or the third locking structure to run therethrough is formed in the separator.

13. The illuminating device according to claim 11, wherein the illuminating device further comprises a light source and a driver driving the light source, the driver is accommodated in the driver housing, wherein the light source is arranged in the first accommodating cavity portion, and the driver housing accommodating the driver is arranged in the second accommodating cavity portion.

14. The illuminating device according to claim 13, wherein the light source comprises at least one LED chip.
